(19) United States
(12) Patent Application Publication
(10) Pub. No.: US 2019/0207219 A1
(43) Pub. Date: Jul. 4, 2019

(54) NEGATIVE ELECTRODE ACTIVE MASS FOR RECHARGEABLE BATTERY, NEGATIVE ELECTRODE FOR RECHARGEABLE BATTERY, AND RECHARGEABLE BATTERY

(71) Applicant: SAMSUNG SDI CO., LTD., Yongin-si (KR)

(72) Inventors: Kunihiko EGUCHI, Yokohama-shi (JP); Iwao FUKUCHI, Yokohama-shi (JP); Isao KOIZUMI, Yokohama-shi (JP); Kenichi KAWASE, Yokohama-shi (JP)

(21) Appl. No.: 16/229,039

(22) Filed: Dec. 21, 2018

(30) Foreign Application Priority Data
Dec. 28, 2017 (JP) 2017-254327
Apr. 26, 2018 (KR) 10-2018-0048588

(51) Int. Cl. H01M 4/62; H01M 4/134; H01M 4/1393; H01M 4/583; H01M 4/131; H01M 4/1395; H01M 10/0525

(52) U.S. Cl. CPC H01M 4/622; H01M 4/134; H01M 4/1393; H01M 2004/027; H01M 4/131; H01M 4/1395; H01M 10/0525; H01M 4/583

(57) ABSTRACT

A negative electrode active mass, a negative electrode, and a rechargeable battery, the active mass including a water-soluble polymer binder; a polymer particle binder; and a negative active material, wherein the water-soluble polymer binder, the polymer particle binder, and the negative active material are included in an amount of about 0.5-2.5:0.5-2.5:95-99, the water-soluble polymer binder includes a copolymer of a carboxyl group-containing acrylic monomer and a water-soluble acrylic acid monomer, repeating units of the water-soluble acrylic acid monomer are included in the copolymer in an amount of about 10 wt % to about 40 wt %, a shear viscosity at 25° C. of an aqueous solution including 1.0 wt % of the copolymer is about 1.0 (Pa·s) to 25 (Pa·s) at a shear rate of 1.0 (1/s), and the negative active material includes graphite particles having a hexagonal interplanar spacing d002 measured by XRD of about 0.3354 nm to 0.3362 nm.

### CROSS-REFERENCE TO RELATED APPLICATIONS

Japanese Patent Application No. 2017-254327 filed in the Japanese Patent Office on Dec. 28, 2017 and Korean Patent Application No. 10-2018-0048588 filed in the Korean Intellectual Property Office on Apr. 26, 2018, and entitled: “Negative Electrode Active Mass for Rechargeable Battery, Negative Electrode for Rechargeable Battery, and Rechargeable Battery,” are incorporated by reference herein in their entirety.

### BACKGROUND

### 1. Field

Embodiments relate to a negative electrode active mass for a rechargeable battery, a negative electrode for a rechargeable battery, and a rechargeable battery.

### 2. Description of the Related Art

A non-aqueous electrolyte rechargeable battery including a lithium ion rechargeable battery may be used as a power source for a portable device such as a laptop computer (note PC), a mobile phone, or the like. Recently, a demand of the non-aqueous electrolyte rechargeable battery for xEV (such as an electric vehicle, a hybrid vehicle, or the like) has increased and thus drawn lots of expectation.

A lithium ion rechargeable battery for xEV may have long-term cycle-life characteristics or high capacity for securing equivalent performance to that of a conventional gasoline engine car. Furthermore, high level safety or high-rate charge characteristics may help complete a charge within equivalent time to fueling time of the gasoline engine car.

### SUMMARY

The embodiments may be realized by providing a negative electrode active mass for a rechargeable battery, the negative electrode active mass including a water-soluble polymer binder; a polymer particle binder; and a negative active material, wherein the water-soluble polymer binder, the polymer particle binder, and the negative active material are included in the negative electrode active mass in a weight ratio of about 0.5-2.5:0.5-2.5:95-99, based on a sum of 100 parts by weight of the water-soluble polymer binder, the polymer particle binder, and the negative active material, the water-soluble polymer binder includes a copolymer of a carboxyl group-containing acrylic monomer and a water-soluble acrylic acid monomer, repeating units of the water-soluble acrylic acid monomer are included in the copolymer in an amount of about 10 wt % to about 40 wt %, based on a total weight of the copolymer, a shear viscosity at 25° C. of an aqueous solution including 1.0 wt % of the copolymer is greater than or equal to about 1.0 (Pa·s) and less than or equal to about 25 (Pa·s) at a shear rate of 1.0 (1/s), and the negative active material includes graphite particles having a hexagonal interplanar spacing d002 measured by XRD of greater than or equal to about 0.3354 nm and less than or equal to about 0.3362 nm.

The negative active material may include the graphite particles in an amount of greater than or equal to about 15 wt % and less than or equal to 100 wt %, based on a total weight of the negative active material.

An R value of Raman spectroscopy of the graphite particles may be greater than or equal to about 0.01 and less than about 0.2, and the R value is expressed by the following equation,

R=ID/IG,

in which R is the R value, ID is a height of a peak detected at around 1360 cm⁻¹, and IG is a height of a peak detected at around 1580 cm⁻¹.

An average particle diameter D50 of the graphite particles may be greater than or equal to about 1 μm and less than about 30 μm.

The graphite particles may include a pore having a pore diameter by a mercury porosimeter of greater than or equal to about 3 μm and less than or equal to about 10 μm in a volume ratio of less than or equal to about 0.7 cc/g.

The embodiments may be realized by providing a negative electrode for a rechargeable battery including the negative electrode active mass according to an embodiment.

The negative electrode may have a degree of orientation of less than or equal to about 15 after being pressed to a density of 1.6 g/cm³, and the degree of orientation is expressed by the following equation:

S=I(004)/I(110),

in which S is the degree of orientation, I(110) is a height of a 110 peak measured by XRD, and I(004) is a height of a 004 peak measured by XRD.

The embodiments may be realized by providing a rechargeable battery comprising the negative electrode for a rechargeable battery according to an embodiment.

### BRIEF DESCRIPTION OF THE DRAWINGS

Features will become apparent to those of skill in the art by describing in detail exemplary embodiments with reference to the attached drawings in which:

FIG. 1 illustrates a schematic cross-sectional side view showing a structure of a rechargeable lithium ion battery.

FIG. 2 illustrates Table 1.

FIG. 3 illustrates Table 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

<1. Structure of Rechargeable Lithium Ion Battery>

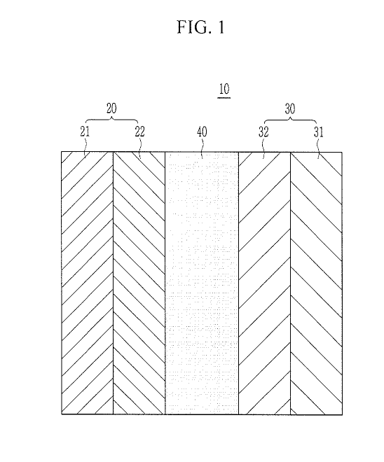

Referring to FIG. 1, a rechargeable lithium ion battery 10 of the present embodiment is described.

The rechargeable lithium ion battery 10 may include a positive electrode 20, a negative electrode 30, a separator 40, and a non-aqueous electrolyte. The rechargeable lithium ion battery 10 may have a charge-reaching voltage (an oxidation reduction potential) of, e.g., greater than or equal to about 4.0 V (vs. Li/Li⁺) and less than or equal to about 5.0 V, or greater than or equal to about 4.2 V and less than or equal to about 5.0 V. In an implementation, the rechargeable lithium ion battery 10 may have a, e.g., cylindrical, prismatic, laminate-type, or button-type shape.

(1-1. Positive Electrode 20)

The positive electrode 20 may include a current collector 21 and a positive active material layer 22. The current collector 21 may include a suitable conductor and may include, e.g., aluminum (Al), stainless steel, or nickel-plated steel.

The positive active material layer 22 may include at least positive active material and may further include a conductive material and a binder for a positive electrode. The positive active material may be, e.g., lithium-containing solid solution oxide, and/or may be a suitable material that may electrochemically intercalate and deintercalate lithium ions. The solid solution oxide may be, e.g., LiₐMnₓCo_{y}Ni_{z}O₂ (1.150≤a≤1.430, 0.45≤x≤0.6, 0.10≤y≤0.15, 0.20≤z≤0.28), LiMnₓCo_{y}Ni_{z}O₂ (0.3≤x≤0.85, 0.10≤y≤0.3, 0.10≤z≤0.3), LiMn_{1.5}Ni_{0.5}O₄.

The conductive material may be, e.g., carbon black such as ketjen black, acetylene black, and the like, natural graphite, artificial graphite, and the like, in order to improve conductivity of a positive electrode.

The binder for a positive electrode may be, e.g., polyvinylidene fluoride, an ethylene-propylene-diene terpolymer, a styrene-butadiene rubber, an acrylonitrile-butadiene rubber, a fluoro rubber, polyvinyl acetate, polymethyl methacrylate, polyethylene, cellulose nitrate, and the like, that binds the positive active material and the conductive material on the current collector 21. The binder for a negative electrode that will be described later may be used as the binder for the positive electrode.

The positive active material layer 22 may be manufactured, e.g., in the following method. First, a positive electrode active mass may be manufactured by dry-mixing the positive active material, the conductive material, and the binder for the positive electrode. Subsequently, the positive electrode active mass may be dispersed in an appropriate organic solvent to form positive electrode active mass slurry, and the positive electrode active mass slurry may be coated on the current collector 21 dried, and compressed to form a positive active material layer.

(1-2. Negative Electrode 30)

The negative electrode 30 may include a current collector 31 and a negative active material layer 32. The current collector 31 may be a suitable conductor and may include or consist of, e.g., aluminum, stainless steel, nickel plated steel, and the like. In an implementation, the negative active material layer 32 may include, e.g., at least a negative active material (C) and a binder for a negative electrode.

The negative active material may include, e.g., at least graphite particles. The graphite particles refer to particles where at least one part of the surface of the particles is graphite. The graphite particles may be, e.g., artificial graphite that is produced by graphitizing graphite precursors of cokes such as coal-based or petroleum-based pure cokes, car sign cokes, needle cokes, mesophase carbons such as mesophase spherule, bulk mesophase, and the like at about 1,500° C. or greater, or about 2,800° C. to about 3,200° C., flake-shaped, or massive natural graphite, or spherical natural graphite produced by spheroidization-pulverization and agglemeration-spheroidization of flake-shaped natural graphite. These may be chemical or physical treatment, e.g., pulverizing, sieving, agglomerating, laminating, compressing, combining, mixing, coating, oxidizing, depositing, mechano chemical treating, edge rounding, spheroidization, curving, heat treatment, and the like. The treated graphite may be mesophasemicrobead (MCMB). The artificial graphite may be produced by performing any one of the above treatments before or after graphitization treatment, and the exemplary thereof may be massive artificial graphite, agglomerated artificial graphite, and the like. In the present embodiment, the graphite particles having the following characteristics are used. The negative active material may include such graphite particles in an amount of greater than or equal to about 15 wt %, e.g., greater than or equal to about 20 wt %, based on a total weight of the negative active material. Maintaining the amount of the graphite particles at 15 wt % or greater may help ensure that the degree of the orientation of the negative electrode (that will be described below) may be less than or equal to about 15 and/or density of the negative electrode may be increased up to 1.6 g/cm³ or greater. In an implementation, the upper limit of the wt % may be less than or equal to about 100 wt %.

(1-3. Graphitization Degree of Graphite Particles)

The graphite particles according to the present embodiment may have a hexagonal interplanar spacing d002 of, e.g., less than or equal to about 0.3362 nm measured by XRD.

Herein, the hexagonal interplanar spacing d002 indicates a graphitization degree of the graphite particles and may be measured by a method of the Japan Society for Promotion of Scientific Research using an XRD (specifically powder X-ray diffraction method). For example, it may be measured by an internal standard method by a Si powder. As the hexagonal interplanar spacing d002 is smaller, crystals are developed (e.g., the graphitization degree may be increased), charge/discharge capacity becomes high, and it may be softer. Maintaining the hexagonal interplanar spacing d002 at about 0.3362 nm or less may help ensure that charge/discharge capacity is sufficient, the graphite particles are not too hard, and a density of the negative active material layer 32 is improved.

The hexagonal interplanar spacing d002 may be less than or equal to, e.g., about 0.3360 nm. In an implementation, the hexagonal interplanar spacing d002 may be, e.g., greater than or equal to about 0.3354 nm, which is a theoretical value of the graphite, or greater than or equal to about 0.3355 nm.

(1-4. Surface Graphitization Degree of Graphite Particles)

An R value of Raman spectroscopy of the graphite particles may be greater than or equal to about 0.01 and less than about 0.2. Herein, the R value refers to a ratio (ID/IG) of a height of a peak (e.g., peak intensity) ID detected at around 1360 cm⁻¹ and a height of a peak IG detected at around 1580 cm⁻¹. For example, the R value may be expressed by the following equation.

R=ID/IG

In the equation, R is the R value, ID is the height of the peak ID detected at around 1360 cm⁻¹, and IG is the height of the peak IG detected at around 1580 cm⁻¹.

The R value indicates a state of crystal development of a surface of the graphite particles (i.e., graphitization degree of the surface). As the R value is larger, a crystal on the surface of the graphite particles is not developed. When the R value is greater than or equal to about 0.2, the graphite particles are hardened so that it may have a defect of too large irreversible capacity, which may be not increased density of the negative active material layer 32 and the like. When the graphite particles are coated with a carbonaceous material on the surface, the R value is increased and in general, in a range of greater than or equal to about 0.2 and less than about 1. In an implementation, the graphite particles may not be coated with the carbonaceous material. In an implementation, as shown in the Examples described below, the graphite particles may be coated with the carbonaceous material, and characteristics of a rechargeable battery may be somewhat less desirable. In an implementation, the R value may have an upper limit of less than about 0.15 and a lower limit of greater than or equal to about 0.03.

The R value may be measured according to the following method. The R values of the Examples described below were measured according to this method. For example, one kind of the graphite particles may be measured ten times under a condition of an excitation wavelength of about 532 nm, a light output of 20 mW, a beam diameter of 0.332 mm, a beam diffusion angle of about 2.10 mrad, exposure time of about 10 seconds, and a cumulative number of ten times by using a laser Raman spectroscopy measurement device (NRS-4100) made by Jasco Corp. The measured spectrum is used to calculate a ratio (ID/IG) of the height of the peak ID detected at around 1360 cm⁻¹ (derived from an amorphous component) and the height of the peak IG detected at around 1580 cm⁻¹ (derived from a graphite component) and thus obtain an arithmetic average of each measurement. The average is regarded as an R value.

(1-5. Average Particle Diameter of Graphite Particles)

An average particle diameter D50 of the graphite particles may be, e.g., greater than or equal to about 1 μm and less than about 30 μm. The average particle diameter D50 may be measured, e.g., by using a laser diffraction particle distribution measuring equipment. Maintaining the average particle diameter at about 1 μm or greater may help ensure that an outside surface area of the graphite particles is not increased, an excessive amount of a binder may not be required to maintain adherence to the negative active material layer 32 and resultantly, high-rate charge performance may be maintained. Maintaining the average particle diameter at about 30 μm or less may help ensure that the graphite particles have a sufficient reaction area and that high-rate charge performance may be maintained. In an implementation, the average particle diameter of the graphite particles desirably may have, e.g., an upper limit of less than or equal to about 25 μm and a lower limit of greater than or equal to about 3 μm.

The average particle diameter may be measured according to the following method. The average particle diameters of the Examples described below were measured according to this method. For example, two ultra-small scoops of the graphite particles and two drops of a non-ionic surfactant (Triton-X; Roche Applied Science) may be added to about 50 ml of water and then, ultrasonic wave-dispersed therein for about 3 minutes. This dispersion is put in a laser diffraction particle distribution measuring equipment (MT3000) made by Microtrac, Inc., and an average particle diameter D50 of the graphite particles at 50% of a cumulative volume is measured.

(1-6. Pore Volume)

The graphite particles may include micropores having a diameter of, e.g., greater than or equal to about 3 μm and less than or equal to about 10 μm, which is measured with a mercury porosimeter, in a volume ratio of less than or equal to about 0.7 cc/g. Maintaining the volume ratio is at about 0.7 cc/g or less may help ensure that an amount of a binder for a negative electrode is not increasingly absorbed into the micropores of the graphite particles, and peel strength of the negative electrode is maintained. In an implementation, the volume ratio may be, e.g., less than or equal to about 0.4 cc/g.

The volume ratio may be measured according to the following method. The volume ratio in the Examples described below was measured according to this method. For example, a micropore volume of the graphite particles in a micro diameter range of greater than or equal to about 3 μm and less than or equal to about 10 μm is measured by using Pore Master 60-GT made by Quanta Chrome Co., charging the graphite particles in a 10 mmφ×30 mm and 0.5 cc stem container, and obtaining a micropore volume distribution in a pressure range corresponding to a micropore diameter of about 400 μm to about 0.0036 μm. This volume is used to calculate the volume ratio.

(1-6. Other Components)

The negative active material may further include other suitable active materials along with the graphite particles, unless an effect according to the present embodiment is deteriorated. The other active materials may include, e.g., soft carbon, hard carbon, silicon or a silicon compound, metals having Li intercalation capability, composite materials thereof, or mixtures thereof.

(1-7. Water-Soluble Polymer Binder (A))

The binder for a negative electrode may include a water-soluble polymer binder and a polymer particle binder. The water-soluble polymer binder may include a copolymer of a carboxyl group-containing acrylic monomer and a water-soluble acrylic acid monomer. In an implementation, repeating units of the water-soluble acrylic acid monomer may be included in an amount of about 10 wt % to about 40 wt %, based on a total weight of the copolymer. In addition, a shear viscosity of an aqueous solution including 1.0 wt % of the copolymer at 25° C. may be greater than or equal to about 1.0 (Pa·s) and less than or equal to about 25 (Pa·s) at a shear rate of 1.0 (1/s).

The water-soluble polymer binder may have the above characteristics, and thus high ion conductivity. For example, internal resistance, specifically negative electrode resistance of the rechargeable lithium ion battery 10, may be decreased. In addition, the water-soluble polymer binder may have good close contacting properties even in a small amount. For example, the water-soluble polymer binder may be used in a small amount to adjust slurry for a negative electrode and may stably bind constituent elements in the negative active material layer 32. In this respect, internal resistance of the rechargeable lithium ion battery 10 and specifically, negative electrode resistance thereof, may be reduced. In addition, deterioration of electronic conductivity due to delamination or structural destruction of an electrode may be suppressed, and a cycle-life of the rechargeable lithium ion battery 10 may be improved.

In an implementation, viscosity may be high in a low shear rate region, and a negative electrode active mass slurry may have satisfactory dispersion stability. For example, viscosity of the negative electrode active mass slurry may be appropriately improved, so that the negative electrode active mass slurry may be easily and stably coated on the current collector 31. In addition, a negative active material may be suppressed from sedimentation in the negative electrode active mass slurry. Maintaining the shear viscosity at about 1.0 (Pa·s) or greater may help ensure that the negative electrode active mass slurry has a high enough viscosity that a sufficient amount of the negative electrode active mass slurry may is retained on the current collector 31. Maintaining the shear viscosity at about 25 (Pa·s) or less may help ensure that the viscosity of the copolymer is low enough that the negative electrode active mass slurry is able to be stirred such that the negative electrode active mass slurry (in which the negative active material and the like is uniformly dispersed) may be prepared. In an implementation, an upper limit of the shear viscosity may be, e.g., 10 (Pa·s).

Herein, in order to obtain the shear viscosity at 25° C. of the aqueous solution including 1.0 wt % of the copolymer of greater than or equal to about 1.0 (Pa·s) and less than or equal to about 25 (Pa·s) at a shear rate of 1.0 (1/s), the carboxyl group-containing acrylic monomer and the water-soluble acrylic acid monomer may be mixed in the weight ratio, and these monomers may be copolymerized without neutralization of the carboxyl group of the carboxyl group-containing acrylic monomer. Accordingly, the copolymer may be synthesized to have a high molecular weight, while an extreme viscosity increase of the reaction solution may be prevented. For example, the copolymer may have a higher molecular weight (e.g., according to the copolymerization reaction), and the copolymer may be slowly precipitated into the reaction solution and becomes white slurry, which may be continuously stirred until the reaction is complete without extremely increasing viscosity of the reaction solution. In addition, this copolymer may realize the aforementioned shear viscosity. If the monomers were to be copolymerized in a state of neutralizing a part or whole of the carboxyl group-containing acrylic monomer, the shear viscosity of the 1.0 wt % copolymer aqueous solution at 25° C. may decrease and thus may become about 1.0 (Pa·s) at a shear rate of less than about 1.0 (1/s).

In an implementation, the carboxyl group-containing acrylic monomer may include. e.g., acrylic acid, methacrylic acid, maleic acid, mono methyl maleic acid, 2-carboxylethyl acrylate, or 2-carboxylethyl methacrylate. In this case, characteristics of the rechargeable lithium ion battery 10 may be further improved.

The water-soluble acrylic acid monomer may include, e.g.; an ethylene glycol chain-containing acrylic monomer or a hydroxy group-containing acrylic monomer. In this case, characteristics of the rechargeable lithium ion battery 10 may be further improved.

The ethylene glycol chain-containing acrylic monomer may include, e.g., 2-methoxyethyl acrylate, 2-ethoxyethylacrylate, 2-(2-methoxyethoxy)ethylacrylate, 2-(2-ethoxyethoxy)ethylacrylate, 2-(2-(2-methoxyethoxy)ethoxy)ethylacrylate, 2-(2-(2-methoxyethoxy)ethoxy)ethylacrylate, methoxy polyethylene glycol acrylate, 2-methoxyethyl methacrylate, 2-ethoxyethylmethacrylate, 2-(2-methoxyethoxy)ethylmethacrylate, 2-(2-ethoxyethoxy)ethylmethacrylate, 2-(2-(2-methoxyethoxy)ethoxy)ethylmethacrylate, 2-(2-(2-methoxyethoxy)ethoxy)ethylmethacrylate, or methoxy polyethylene glycol methacrylate. In this case, characteristics of the rechargeable lithium ion battery 10 may be further improved.

The hydroxy group-containing acrylic monomer may include, e.g., 2-hydroxyethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxypropyl methacrylate, 3-hydroxypropyl methacrylate, 2-hydroxybutyl methacrylate, or 4-hydroxybutyl methacrylate. In this case, characteristics of the rechargeable lithium ion battery 10 may be further improved.

At least one part of the carboxyl group-containing acrylic monomer may be an alkali metal salt or an ammonium salt. In this case, characteristics of the rechargeable lithium ion battery 10 may be further improved.

(1-8. Polymer Particle Binder (B))

The polymer particle binder may be dispersed in the negative electrode active mass slurry (e.g., negative electrode active mass) with a particle phase and in the negative active material layer 32, and may bind the negative active materials each other and the negative active material and the current collector 31. The polymer particle binder may be a particle phase, and ion conductivity of water-soluble polymer binder may not be inhibited.

The polymer particle binder may include various polymers. An example of the polymer particle binder may include a non-water-soluble polymer. Such a polymer may include, e.g., polyethylene, polytetrafluoroethylene (PTFE), polyvinylidene fluoride (PVDF), tetrafluoroethylene-hexafluoro propylene copolymer (FEP), polyacrylic acid derivative, polyacrylonitrile derivative, or the like.

In an implementation, particles of soft polymer may be used as the polymer particle binder.

(i) Acryl-based soft polymer (ACL), e.g., homopolymers of acrylic acid or methacrylic acid derivatives of polybutyl acrylate, polybutyl methacrylate, polyhydroxyethylmethacrylate, poly acrylamide, polyacrylonitrile, a butyl acrylate.styrene copolymer, a butyl acrylate.acrylonitrile copolymer, a butyl acrylate.acrylonitrile.glycidyl methacrylate copolymer, and the like, or copolymers of copolymerizable monomers therewith,

(ii) Isobutylene-based soft polymers of poly isobutylene, an isobutylene.isoprene rubber, an isobutylene.styrene copolymer, and the like,

(iii) Diene-based soft polymers, e.g., polybutadiene, polyisoprene, a butadiene.styrene random copolymer, an isoprene.styrene random copolymer, an acrylonitrile.butadiene copolymer, an acrylonitrile.butadiene.styrene copolymer, a butadiene.styrene.block copolymer, a styrene.butadiene.styrene.block copolymer, an isoprene.styrene.block copolymer, a styrene.isoprene.styrene.block copolymer, a styrene.butadiene.metacrylic acid copolymer, a styrene.butadiene.itaconic acid.2-hydroxyethyl acrylate copolymer, and the like,

(iv) Silicon-containing soft polymer, e.g., dimethylpolysiloxane, diphenylpolysiloxane, dihydroxypolysiloxane, and the like,

(v) Olefin-based soft polymer, e.g., liquid polyethylene, polypropylene, poly-1-butene, an ethylene.α-olefin copolymer, a propylene.α-olefin copolymer, an ethylene.propylene.diene copolymer (EPDM), an ethylene.propylene.styrene copolymer, and the like,

(vi) Vinyl-based soft polymer, e.g., polyvinyl alcohol, poly vinyl acetate, poly vinyl stearate, a vinyl acetate.styrene copolymer, and the like,

(vii) Epoxy-based soft polymer. e.g., polyethylene oxide, polypropylene oxide, an epichlorohydrin rubber and the like.

(viii) Fluorine-containing soft polymer, e.g., a vinylidene fluoride-based rubber, a tetrafluoroethylene-propylene rubber, and the like, and

(ix) Other soft polymers, e.g., a natural rubber, polypeptide, a protein, a polyester-based thermoplastic elastomer, a vinyl chloride-based thermoplastic elastomer, a polyamide-based thermoplastic elastomer, and the like.

In an implementation, the diene-based soft polymer and the acryl-based soft polymer may be used. These soft polymers may have cross-linking structures or may have a functional group by modification.

One kind of the polymer particle binder may be used alone or two or more kinds may be combined in any ratio.

A method of manufacturing the binder of the polymer particles may include, e.g., a solution polymerization method, a suspension polymerization method, an emulsion polymerization method, or the like.

In an implementation, the suspension polymerization method and the emulsion polymerization method may be adopted in terms of performing a polymerization in water and using the binder itself as a material for negative electrode active mass slurry. In addition, when the polymer particle binder is prepared, it is desirably that the reaction system includes a dispersing agent.

(1-9. Weight Ratio)

A weight ratio (weight ratio of solids) of the water-soluble polymer binder, the polymer particle binder, and the negative active material may be, e.g., 0.5 to 2.5:0.5 to 2.5:95 to 99, based on a sum of 100 parts by weight thereof. Maintaining the weight ratio of the water-soluble polymer binder and the polymer particle binder within this range may help ensure that the negative electrode 30 has sufficient peel strength and may not be peeled off when cut and wound and deteriorate a cycle-life. Maintaining the weight ratio of the water-soluble polymer binder and the polymer particle binder within the range may help ensure that ion conductivity or electron conductivity is not deteriorated, and thus high-rate charge performance may be maintained.

(1-10. Density of Negative Electrode)

In an implementation, the negative electrode 30 may include graphite particles having a high graphitization degree. For example, the negative electrode 30 may have high density and high capacity. In an implementation, a density (density of a solid) of the negative electrode 30 may be, e.g., greater than or equal to about 1.6 g/cm³.

(1-11. Degree of Orientation)

In an implementation, when the negative electrode 30 is pressed to have solid density of about 1.6 g/cm³, the negative electrode 30 may have a degree of orientation less than or equal to about 15. Herein, the degree of orientation is a ratio between a height of a (110) peak I(110) and a height of a (004) peak I(004), which are measured with an X-ray diffraction device (XRD). For example, the degree of orientation is expressed by the following equation.

S=I(004)/I(110)

In the equation S is the degree of orientation, I(110) is the height of the (110) peak measured by XRD, and I(004) is the height of the (004) peak measured by XRD

Maintaining the degree of orientation at about 15 or less may help ensure that fluidity of an electrolyte solution in the negative active material layer 32 is not deteriorated, expansion/contraction of the graphite particles accompanied with the charge/discharge is not sharply increased, and that high-rate charge performance or a cycle-life is not deteriorated. In an implementation, the degree of orientation may be, e.g., less than or equal to about 10.

The degree of orientation may be measured according to the following method. The degree of orientation of the Examples described below may be measured in this method. For example, the negative electrode active mass slurry (negative electrode active mass) is coated on a copper foil as a current collector, dried, and pressed to adjust density of the negative active material layer 32 to about 1.6 g/cm³. Subsequently, the negative electrode 30 is pierced out to about 16 mmφ and adhered to a glass plate, and a ratio I(004)/I(110) between a peak height derived from a (004) plane of the graphite particles and a peak height derived from a (110) plane thereof is calculated through the X diffraction measurement. Herein, the (110) peak height is derived from an ab-axis direction of graphite crystals, and the (004) peak height is derived from a c-axis direction thereof.

(1-12. Separator)

The separator 40 may be a suitable separator for a rechargeable lithium ion battery. The separator may include a porous layer or a non-woven fabric having excellent high-rate discharge performance, which may be used alone or in a mixture thereof. The resin of the separator may be, e.g., a polyolefin-based resin such as polyethylene or polypropylene, a polyester-based resin such as polyethylene terephthalate or polybutylene terephthalate, PVDF, a vinylidene fluoride (VDF)-hexafluoro propylene (HFP) copolymer, a vinylidene fluoride-perfluoro vinylether(par fluorovinyl ether) copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoro acetone copolymer, a vinylidene fluoride-ethylene copolymer, a vinylidene fluoride-propylene copolymer, a vinylidene fluoride-trifluoro propylene copolymer, a vinylidene fluoride-tetrafluoroethylene-hexafluoro propylene copolymer, a vinylidene fluoride-ethylene-tetrafluoroethylene copolymer, and the like.

(1-13. Non-Aqueous Electrolyte)

The non-aqueous electrolyte may be a suitable non-aqueous electrolyte for a rechargeable lithium battery. The non-aqueous electrolyte may have a composition where an electrolytic salt in a non-aqueous solvent. The non-aqueous solvent may include, e.g., cyclic carbonate esters such as propylene carbonate, ethylene carbonate, butylene carbonate, chloroethylene carbonate, or vinylene carbonate; cyclic esters such as γ-butyrolactone, or γ-valero lactone; linear carbonates such as dimethyl carbonate, diethyl carbonate, or ethyl methyl carbonate; linear esters such as methyl formate, methyl acetate, or butyric acid methyl; tetrahydrofuran or a derivative thereof; ethers such as 1,3-dioxane, 1,4-dioxane, 1,2-dimethoxyethane, 1,4-dibutoxyethane, or methyl diglyme; nitriles such as acetonitrile, or benzonitrile; dioxolane or a derivative thereof; ethylene sulfide, sulfolane, sultone or a derivative thereof, and the like, which may be used alone or as a mixture of two or more.

The electrolytic salt may include, e.g., an inorganic ion salt including lithium (Li), sodium (Na) or potassium (K) such as LiClO₄, LiBF₄, LiAsF₆, LiPF₆, LiPF₆₋ₓ(CₙF₂ₙ₊₁)ₓ [wherein, 1<x<6, and n=1 or 2], LiSCN, LiBr, LiI, Li₂SO₄, Li₂B₁₀Cl₁₀, NaClO₄, NaI, NaSCN, NaBr, KClO₄, KSCN, and the like, an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, lithium stearyl sulfate, lithium octyl sulfate, lithium dodecylbenzene sulphonate. These may be used alone or in a mixture of two or more. The concentration of the electrolytic salt may be a suitable concentration for a rechargeable lithium battery.

In an implementation, an electrolyte solution including an appropriate lithium compound (electrolytic salt) at a concentration of about 0.8 mol/L to about 1.5 mol/L may be used.

The non-aqueous electrolyte may further include a suitable additive. The additives may include, e.g., a negative electrode-acting additive, a positive electrode-acting additive, an ester-based additive, a carbonate ester-based additive, a sulfuric acid ester-based additive, a phosphoric acid ester-based additive, a boric acid ester-based additive, an acid anhydride additive, and an electrolytic additive. Of these, at least one may be added to the non-aqueous electrolyte, and a plurality of additives may be added to the non-aqueous electrolyte.

<2. Method of Manufacturing Rechargeable Lithium Ion Battery>

Next, a method of manufacturing a rechargeable lithium ion battery 10 is described. The positive electrode 20 may be manufactured as follows. First, a mixture of a positive active material, a conductive material, and a binder for a positive electrode in the above ratio may be dispersed in a solvent (e.g., N-methyl-2-pyrrolidone) to prepare slurry. Subsequently, the slurry may be coated on a current collector 21 and dried to form a positive active material layer 22. The coating method may be, e.g., a knife coater method, a gravure coater method, and the like. The below coating process may be performed according to the same method. Subsequently, the positive active material layer 22 may be compressed with a press so as to have a density within the ranges. According to the processes, the positive electrode 20 is manufactured.

The negative electrode 30 may be manufactured according to the same method as that of the positive electrode 20. First, a mixture of a negative active material and a binder for a negative electrode may be dispersed in a solvent (e.g., water) to prepare slurry (negative electrode active mass slurry). In an implementation, the negative electrode active mass slurry may be a dispersion of the negative electrode active mass (mixtures of negative electrode materials (solids)) in a solvent. Subsequently, the slurry may be coated on the current collector 31 and dried to form a negative active material layer 32. The drying may be performed at, e.g., a temperature of about 150° C. or greater. Then, the negative active material layer 32 may be compressed with a press so as to have a density within the above ranges. According to the processes, the negative electrode 30 is manufactured.

Subsequently, the separator 40 may be disposed between the positive electrode 20 and the negative electrode 30 to manufacture an electrode structure. Then, the electrode structure may be manufactured to have a desired shape (for example, a cylinder, a prism, a laminate, a button, and the like) and then inserted into a container having the same shape. Then, a non-aqueous electrolyte may be injected into the container in order to impregnate the electrolyte solution into each pore of the separator 40. In this way, a rechargeable lithium ion battery may be manufactured.

In an implementation, the negative active material may use graphite particles having a high graphitization degree and thus may be expected to accomplish high capacity. When graphite particles are used, high-rate charge/discharge characteristics and cycle-life characteristics could be deteriorated. Accordingly, the water-soluble polymer binder and the polymer particle binder having the aforementioned characteristics may be used in the present embodiment. The water-soluble polymer binder may have satisfactory close contacting properties, even when used in a small amount. Accordingly, an amount of the binder in the negative active material layer may be reduced, internal resistance may be reduced, and high-rate charge/discharge characteristics may be improved. In addition, the water-soluble polymer binder itself may have high ion conductivity, the internal resistance may be reduced in this respect, and the high-rate charge/discharge characteristics may be improved. The water-soluble polymer binder may have high close contacting properties even in a small amount and thus may help maintain high peel strength and improve cycle-life characteristics.

### EXAMPLES

<1. Synthesis of Water-Soluble Polymer Binder (A)>

Hereinafter, Examples of the present embodiment are described. First, Synthesis Example of the water-soluble polymer binder is described. A combination ratio of monomers is weight ratio (weight %) unless particularly described otherwise.

Lithium polyacrylate/polyacrylic acid 2-(2-ethoxyethoxy)ethyl(2-(2-ethoxyethoxy)ethylacrylate)=90/10 was synthesized through the following processes.

1150 g of distilled water, acrylic acid (90 g, 1.249 mol), and acrylic acid 2-(2-ethoxyethoxy)ethyl (10 g, 0.053 mol) were put in a 2,000 ml 5-necked separable flask equipped with a mechanical stirrer, a stirring bar, a temperature sensor, and a condenser and then, stirred at 300 rpm, and a process of reducing an internal pressure down to 10 mmHg and recovering the internal pressure up to a normal pressure with nitrogen with a diaphragm pump was repeated three times. When the reaction solution was heated and reached a temperature of 65° C., ammonium persulfate (0.297 g, 0.00130 mol) as an initiator dissolved in 0.3 ml of distilled water was added thereto. The obtained mixture was heated for 2 hours by setting the heated temperature at 80° C. and reacted for 2 hours again by increasing the temperature up to 90° C. to obtain a polymer composition as a white slurry-type solid.

The resultant was cooled down to ambient temperature, and then, a polymer composition therefrom was moved to a 10 L container, and 4,077 ml of distilled water was added thereto to dilute it. Subsequently, while stirred in the mechanical stirrer, lithium hydroxide monohydrate (47.17 g, 0.9 equivalent based on the acrylic acid) was added thereto, and the resultant was stirred until the polymer composition was completely dissolved and the solution became uniform.

5 ml of the reaction solution was taken therefrom to measure non-volatile (NV) components, and the result was 2.0% (a theoretical value of 2.0%).

In addition, the reaction solution was diluted to have the non-volatile (NV) components of 1%, and then, when shear viscosity thereof at 25° C. was measured, the result was 7.6 (Pa·s) at a shear rate of 1.0 (1/s).

<2. Manufacture of Negative Active Material (C)>

Negative active materials of each Example and Comparative Example were manufactured through the following processes.

### 2-1. Examples 1 and 2 and Comparative Examples 1 to 3

A graphite precursor was obtained by sintering coal tar pitch at 500° C. for 10 hours under a nitrogen flow. The graphite precursor was coarsely ground and edge-rounded with a ball mill to have an average particle diameter D50 of 16 μm. Subsequently, the graphite precursor was graphitized at 3,000° C. for 5 hours under an argon atmosphere, and then, after separating and removing fine particles therefrom, the graphitized graphite precursor was sieved with a 53 μm-sized sieve.

The obtained graphite particles had massiveness and an average particle diameter D50 of 15 μm. DO of 1.5 μm, d002 of 0.3359 nm from an X-ray diffraction, a R value of 0.05 from Raman spectroscopy, and 0.65 cc/g of a volume ratio of micropores having a diameter of greater than or equal to 3 μm and less than or equal to 10 μm.

### 2-2. Example 3 and Comparative Example 4

Petroleum-based needle coke was pulverized with a jet mill and adjusted to have an average particle diameter D50 of 5 μm. The fine coke particles along with coal tar pitch (a residual carbon rate of 60%) in the same weight were put in a two axes-heating kneader, kneaded at 200° C. for 1 hour, and sintered at 480° C. for 10 hours under a nitrogen flow to obtain a graphite precursor. The graphite precursor was coarse-ground, edge-rounded with a ball mill, and adjusted to have an average particle diameter D50 of 18 μm. Subsequently, a product therefrom was graphitized at 3,000° C. for 5 hours under an argon atmosphere and then, after separating and removing fine particles, sieved with a 53 μm sieve.

The obtained graphite particles had an agglomerated massiveness formed of agglomerated plate-type primary particles, and had an average particle diameter D50 of 17 μm and DO of 1.5 μm, d002 of 0.3358 nm through an X-ray diffraction, R of 0.06 through Raman spectroscopy, and 0.65 cc/g of a volume ratio of micropores having a diameter of greater than or equal to 3 μm and less than or equal to 10 μm measured by using a mercury porosimeter.

### 2-3. Example 4 and Comparative Example 5

A mesophase spherule sintering product having an average particle diameter of 22 μm was graphitized under an argon atmosphere at 3,000° C. for 5 hours and sieved with a 53 μm sieve.

The obtained graphite particles were spherical and had an average particle diameter D50 of 20 μm and DO of 4.5 μm, d002 of 0.3361 nm through an X-ray diffraction, R of 0.17 through Raman spectroscopy, and 0.03 cc/g of a volume ratio of micropores having a diameter of greater than or equal to 3 μm and less than or equal to 10 μm by a mercury porosimeter.

### 2-4. Examples 2 and 3 and Comparative Example 4

Flake-shaped natural graphite having an average particle diameter of 52 μm was pulverized with a pin mill having a circulating power equipment and simultaneously, bent and rounded to obtain a spherical natural graphite having an average particle diameter D50 of 15 μm. Subsequently, 1 part by weight of an ethanol solution of a novolac phenolic resin when converted into a residual carbon was added to 100 parts by weight of the spherical natural graphite, and the mixture was stirred, sintered under a nitrogen atmosphere at 1,000° C. for 3 hours, and sieved with a 53 μm sieve.

The spherical natural graphite coated with a carbonaceous material was obtained and had an average particle diameter D50 of 15 μm and DO of 7 μm, d002 of 0.3356 nm through an X-ray diffraction, and R of 0.32 through Raman spectroscopy.

### 2-5. Example 5

A flake-shaped natural graphite having an average particle diameter of 52 μm was pulverized with a pin mill having a circulating power equipment and simultaneously, bent and rounded to obtain a spherical natural graphite having an average particle diameter D50 of 15 μm. Subsequently, 5 parts by weight of fine coal tar pitch particles having an average particle diameter D50 of 3 μm when converted into a residual carbon was added to 100 part by weight of the spherical natural graphite, and the mixture was sintered at 1.000° C. for 3 hours under a nitrogen atmosphere and sieved with a 53 μm sieve.

The spherical natural graphite coated with a carbonaceous material was obtained and had an average particle diameter D50 of 15 μm and DO of 7 μm, d002 of 0.3361 nm through an X-ray diffraction, and R of 0.28 through Raman spectroscopy.

<3. Manufacture of Negative Electrode>

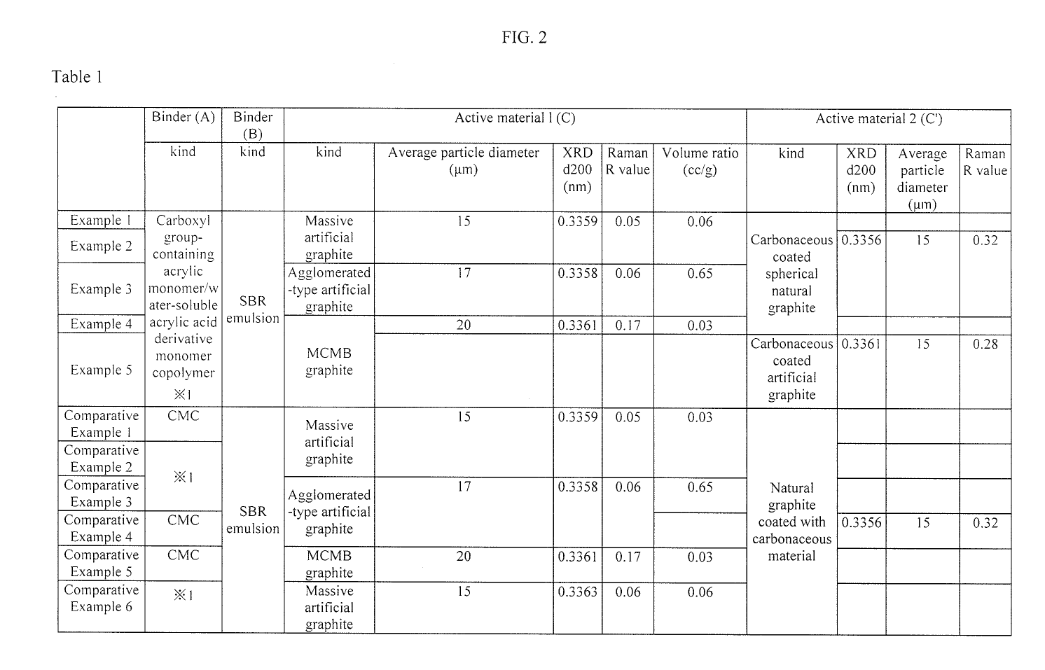

The negative active material, the water-soluble polymer binder, and styrene butadiene copolymer (SBR) (B) were mixed as described in Table 1 of FIG. 2 to prepare an aqueous negative electrode active mass slurry. The negative electrode active mass slurry included non-volatile components of 50 wt % based on the total weight of the slurry.

Subsequently, a gap of a bar coater was adjusted so as to coat the mixture in a coating amount (surface density) of 11.5 mg/cm² after the drying and the negative electrode active mass slurry was uniformly coated on a copper foil (current collector, thickness 10 μm). Then, the negative electrode active mass slurry was dried with a blowing dryer set at 80° C. for 15 minutes. Then, the dried negative electrode active mass was pressed with a roll press to have an active mass density of 1.6 g/cm³. Then, the negative electrode active mass was vacuum-dried at 150° C. for 6 hours, manufacturing a negative electrode.

<4. Manufacture of Positive Electrode>

(Preparation of Positive Electrode Active Mass Slurry)

97.4 wt % of a solid solution oxide Li_{1.20}Mn_{0.55}Co_{0.10}Ni_{0.15}O₂, 1.3 wt % of ketjen black, and 1.3 wt % of polyvinylidene fluoride were dispersed in N-methyl-2-pyrrolidone to prepare positive electrode active mass slurry. The positive electrode active mass slurry included non-volatile components of 50 wt % based on the total weight of the slurry.

Subsequently, the gap of the bar coater was adjusted so as to coat the mixture in a coating amount (surface density) of 21.6 mg/cm² after the drying, and the positive electrode active mass slurry was coated on an aluminum current collector foil with the bar coater. Then, the positive electrode active mass slurry was dried with a blowing dryer set at 80° C. for 15 minutes.

Then, the dried resultant was pressed with a roll press to have an active mass density of 3.7 g/cm³. Then, the pressed resultant was vacuum-dried at 80° C. for 6 hours, manufacturing a sheet-type positive electrode including a positive current collector and a positive active material layer.

<5. Manufacture of Rechargeable Battery Cell>

The negative electrode was cut into a disk having a diameter of 1.55 and the positive electrode manufactured in the positive electrode manufacturing example was cut into a disk having a diameter of 1.3 cm. Subsequently, a separator (25 μm-thick polyethylene microporous film) was cut into a disk having a diameter of 1.8 cm. The positive electrode disk having a diameter of 1.3 cm, the separator disk having a diameter of 1.8 cm, the negative electrode disk having a diameter of 1.55 cm, and a 200 μm-thick copper foil disk having a diameter of 1.5 cm were sequentially stacked into a stainless steel coin container having a diameter of 2.0 cm. Then, 150 μL of an electrolyte solution (1.4 M LiPF₆ dissolved in a 10/70/20 volume ratio mixed solvent of ethylene carbonate/diethyl carbonate/fluoroethylene carbonate) was inserted into the container. Subsequently, the container was covered with a stainless steel cap after inserting a polypropylene packing therebetween and sealed with an assembler. Accordingly, a rechargeable lithium ion battery cell (coin cell) was manufactured.

<6. Evaluation of High-Rate Charge Performance and Cycle-Life>

Each rechargeable lithium ion battery cell according to Examples and Comparative Examples was first constant current (CC)-charged up to 4.2V at 0.5 C, constant voltage (CV)-charged to a cutoff of 0.02 C, and then, CC-discharged to 2.8 V at 0.5 C at 25° C.

Subsequently, the cell was CC-charged up to 4.2 V at 3 C, CV-charged to a cutoff of 0.02 C, and subsequently, CC-discharged down to 2.8 V at 0.5 C for a cycle experiment. This cycle was 50 times repeated. The same measurement was performed at n=3.

Based on 100 of an arithmetic average of the first 3C-CC capacity the rechargeable battery cell according to Comparative Example 1 in the cycle experiment, the same charge capacity of each Example and Comparative Example (high-rate charge/discharge characteristics) was relatively calculated. In addition, based on 100 of discharge capacity after 50 cycles of each Example and Comparative Example, the discharge capacity at the same cycles of Comparative Example 1 was measured (cycle-life characteristics).

<7. Evaluation of Close Contacting Properties>

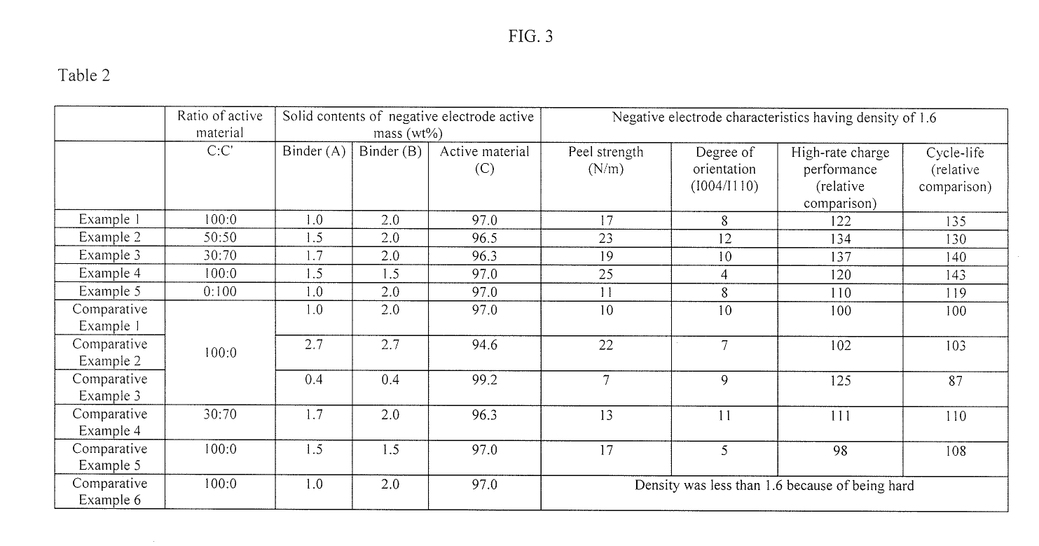

The manufactured negative electrodes were cut into a 25 mm-wide and 100 mm-long rectangular shape. Then, the cut electrodes were adhered to a stainless steel plate faced with the active material surface thereof by using a double-sided adhesive tape to manufacture samples for testing peel strength. The samples for a peeling strength test were mounted on a peeling tester (SHIMAZU EZ-S, Schimazu Scientific Instruments) and their peeling strengths at 180° were measured. The results are shown in Table 2 of FIG. 3. Referring to Table 2, Examples 1 to 5 exhibited high close contacting properties, high-rate charge/discharge characteristics, and cycle-life characteristics. In addition, Examples 1 to 5 used graphite particles having a high graphitization degree and may be expected to exhibit high capacity.

By way of summation and review, if a lithium ion rechargeable battery were to be charged at a high rate, high capacity and cycle-life characteristics could be damaged. For example, when a lithium ion rechargeable battery is charged, lithium ions released from a positive active material during the charge are inserted into a negative active material. If the charge were to be performed with a higher current than capability of the battery, the lithium ions may not be appropriately inserted into the negative active material, e.g., may be precipitated as metallic lithium.

The precipitated metallic lithium may undergo an irreversible reaction with an electrolyte solution and may become a lithium compound and then, may no longer participate in charge/discharge. As a result, the battery capacity could be deteriorated, which may be faster than when used within a nominal charge current. For example, when high-rate charged, a rechargeable battery may be charged faster but may be damaged, and its cycle-life characteristics may be deteriorated.

Accordingly, improvement of the high-rate charge/discharge characteristics may be considered. For example, a method of increasing a graphitization degree of graphite particles including the negative active material as technology for accomplishing high capacity of a rechargeable battery may be considered. When the graphitization degree of the graphite particles is increased, discharge capacity and density of a negative electrode may be increased, which may be effective on accomplishing the high capacity of the rechargeable battery (e.g., improving volume capacity).

As the graphitization degree is higher, ion conductivity in a negative active material layer may deteriorate along with the high-rate charge/discharge characteristics. As another technology for accomplishing high-rate charge and discharge characteristics of a rechargeable battery, a method of reducing an amount of a binder in the negative active material layer may be considered. Peel strength of the negative electrode may deteriorate by only reducing the amount of a binder and cycle-life characteristics may also deteriorate.

On the other hand, a slurry composition for a negative electrode of a rechargeable battery, which includes a water-soluble polymer (including a silicon-containing monomer unit), a particle-shaped binder, water, and an active material including a silicon-containing compound is provided. However, in some water-soluble polymers for a main purpose of dispersing the active material including a silicon-containing compound, the polymer may lack ion conductivity and may show insufficient high-rate charge performance.

The embodiments may provide a negative electrode active mass for a rechargeable lithium battery capable of improving high-rate charge/discharge characteristics and cycle-life characteristics even in case of using graphite particles having a high graphitization degree.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

10 rechargeable lithium ion battery
20 positive electrode
30 negative electrode
40 separator

What is claimed is:

1. A negative electrode active mass for a rechargeable battery, the negative electrode active mass comprising:
a water-soluble polymer binder;
a polymer particle binder; and
a negative active material,
wherein:
the water-soluble polymer binder, the polymer particle binder, and the negative active material are included in the negative electrode active mass in a weight ratio of about 0.5-2.5:0.5-2.5:95-99, based on a sum of 100 parts by weight of the water-soluble polymer binder, the polymer particle binder, and the negative active material,
the water-soluble polymer binder includes a copolymer of a carboxyl group-containing acrylic monomer and a water-soluble acrylic acid monomer,
repeating units of the water-soluble acrylic acid monomer are included in the copolymer in an amount of about 10 wt % to about 40 wt %, based on a total weight of the copolymer,
a shear viscosity at 25° C. of an aqueous solution including 1.0 wt % of the copolymer is greater than or equal to about 1.0 (Pa·s) and less than or equal to about 25 (Pa·s) at a shear rate of 1.0 (1/s), and
the negative active material includes graphite particles having a hexagonal interplanar spacing d002 measured by XRD of greater than or equal to about 0.3354 nm and less than or equal to about 0.3362 nm.

2. The negative electrode active mass as claimed in claim 1, wherein the negative active material includes the graphite particles in an amount of greater than or equal to about 15 wt % and less than or equal to 100 wt %, based on a total weight of the negative active material.

3. The negative electrode active mass as claimed in claim 1, wherein:
an R value of Raman spectroscopy of the graphite particles is greater than or equal to about 0.01 and less than about 0.2, and
the R value is expressed by the following equation,
R=ID/IG,
in which R is the R value, ID is a height of a peak detected at around 1360 cm⁻¹, and IG is a height of a peak detected at around 1580 cm⁻¹.

4. The negative electrode active mass as claimed in claim 1, wherein an average particle diameter D50 of the graphite particles is greater than or equal to about 1 μm and less than about 30 μm.

5. The negative electrode active mass as claimed in claim 1, wherein the graphite particles include a pore having a pore diameter by a mercury porosimeter of greater than or equal to about 3 μm and less than or equal to about 10 μm in a volume ratio of less than or equal to about 0.7 cc/g.

6. A negative electrode for a rechargeable battery comprising the negative electrode active mass as claimed in claim 1.

7. The negative electrode as claimed in claim 6, wherein:
the negative electrode has a degree of orientation of less than or equal to about 15 after being pressed to a density of 1.6 g/cm³, and
the degree of orientation is expressed by the following equation:
S=I(004)/I(110),
in which S is the degree of orientation, I(110) is a height of a 110 peak measured by XRD, and I(004) is a height of a 004 peak measured by XRD.

8. A rechargeable battery comprising the negative electrode for a rechargeable battery as claimed in claim 7.
